(19) United States
(12) Patent Application Publication
(10) Pub. No.: US 2010/0111772 A1
(43) Pub. Date: May 6, 2010

(54) GAS AND LIQUID IMPERMEABLE CAP

(76) Inventor: Christopher Hartofelis, Westford, MA (US)

Correspondence Address: CORNING INCORPORATED, SP-TI-3-1, CORNING, NY, 14831, US

(21) Appl. No.: 12/466,067

(22) Filed: May 14, 2009

Related U.S. Application Data
(60) Provisional application No. 61/110,181, filed on Oct. 31, 2008.

(51) Int. Cl. B01L 3/00

(52) U.S. Cl. 422/102

(57) ABSTRACT

A media container and associated liquid and gas impermeable cap that fits over the opening of the container is disclosed. The cap has a skirt and top portion. On the top of the cap is an access port used for accessing contents within the container. In one embodiment, three protective layers within the cap design create a liquid impermeable and gas impermeable barrier. First, a septum is integrally connected with the inner surface of the top of the cap, next a peal-away film layer covers the access port. Finally, a gas impermeable liquid impermeable film or layer bonds to the portion of the septum facing the interior of the container.

### CLAIMING BENEFIT OF PRIOR FILED U.S. APPLICATION

This application claims the benefit of U.S. Provisional Application Ser. No. 61/110,181, filed on Oct. 31, 2008. The content of this document and the entire disclosure of any publication, patent, or patent document mentioned herein is incorporated by reference.

### BACKGROUND

The use of buffered growth media for microbiological assays and/or cell culture is widespread. To obtain accurate assays, it is important that the volume of the fluid be exact to obtain proper dilution of, for example, a bacteria-containing sample, and of paramount importance that its sterility is ensured. It is also important that the concentration of the buffer or growth media components have a predetermined known value. Further, for certain assays, maintaining the pH of the buffer is critical. This may be achieved by the preparation of fresh batches of the assay fluids, measuring and/or adjusting the concentration of the components, then using the assay fluids promptly thereafter. The chief drawback of this approach is that it is both time-consuming, labor-intensive and subjects the assay fluid to the possible introduction of sterility-destroying microorganisms.

An alternative, simpler approach has been to use premade sterile media assay fluids that come in specific volumes and concentrations. However, in order to maintain sterility and the proper volume and concentration during storage and shipping, such premade fluids must be contained in fluid-tight containers that prevent the entry of microorganisms or oxygen and that permit essentially no loss of fluid either through leakage or evaporation. This may be achieved by the use of a container having, for example, a molded breakable seal formed essentially integrally with the container's opening. The drawback of such an approach is that, once the seal is broken, the fluid must be used immediately and any remainder discarded.

Another alternative involves the use of a fluid and air tight septum integrally bonded to the underside of the cap's top surface. So long as there exists an access port within the cap top, one may access by needle the liquid media within the container while maintaining sterility of the contents. However, such an arrangement allows for media to seep along the interface of the septum and the cap and thereby allowing leakage through the access port or allowing air to enter the container thereby disrupting the sterility of the contents, and potentially changing the pH of the reagent solution.

The achievement of absolutely fluid-tight reusable containers has been difficult, with even the most fluid-tight containers exhibiting leakage when they are shipped by air, where the lower atmospheric pressure existing at high altitudes, coupled with a lowered vapor pressure of the fluid combine to create a higher relative pressure inside the container, thereby tending to force the liquid out of the container.

There is therefore a need in the art for a fluid-tight container that exhibits essentially no loss of fluid during storage and shipping, including shipment by air, that remains sterile until it is used and that, once opened, may again be sealed to maintain sterility and the predetermined volume and concentration of the assay fluid's components, and which permits retesting of the assay fluid in a simple and convenient manner.

The foregoing need is met by the present invention, which is summarized and described in detail below.

### BRIEF SUMMARY

The invention relates to a media container and a cap that fits over the opening of the container, the container and cap being provided with various features aimed at creating a fluid-tight seal even at the high altitudes encountered during shipment by airplane. The top of the container is provided with a lip, and screw threads below the lip; these features preferably being integrally molded with the top of the container. The cap has a skirt and top portion. On the top of the cap is an access port used for accessing contents within the container. The inside of the cap is provided with screw threads to mate with the screw threads of the top of the container. Three protective layers within the cap design create a liquid impermeable and gas impermeable barrier. First, a septum is integrally connected with the inner surface of the top of the cap, next a peal-away film layer covers the access port. Finally, a gas impermeable liquid impermeable film or layer bonds to the portion of the septum facing the interior of the container.

### BRIEF DESCRIPTION OF THE DRAWINGS

FIG. 1 is an exploded perspective view of the cap of the invention.

FIG. 2 is a cross section view of the cap of the present invention.

FIG. 3 is an enlarged detailed view of an identified portion of the cap of FIG. 2.

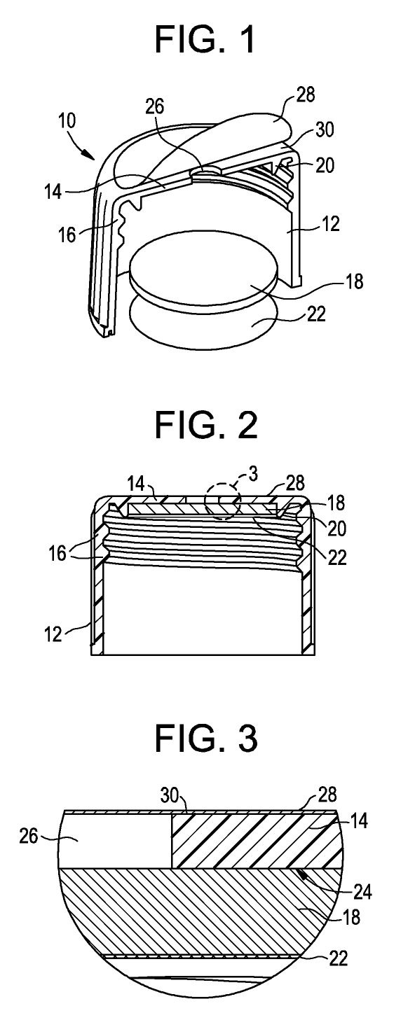

### DETAILED DESCRIPTION

Referring to the drawings, wherein like numerals refer to the same elements, there is shown the inventive cap. Cap comprises

Cap 10 comprises a circumferential skirt 12 and integral circular top 14. Skirt 12 is provided on its inner wall with screw threads 16 adapted to engage corresponding screw threads of a container. Fitted within the cap is a cylindrical shaped septum 18. The septum fittingly engages an annular ring 20 extending from the inner surface of the cap top 14. The diameter of the septum 18 is approximately equal to the diameter of the annular ring 20. As such, the septum nests within the annular ring.

In general, the septum is puncturable by a sharp needle typically used for piercing hard rubber septa, for example. In another embodiment, the septum is punctuarable by relatively wide diameter liquid sampling instruments, of plastic, metal or other material, which do not have a sharp needle point at the tip of the type used for piercing conventional harder rubber septa. In such an embodiment, the septum must be thin enough to be punctured by a blunt instrument.

Another characteristic of the septum is the septum's ability to substantially self-reseal following puncture to a condition where the septum is substantially closed against spillage during normal handling of the container on the laboratory premises following puncture of the septum by a sampling implement.

The resilient material of the puncturable septum 18 may be a silicone rubber having a thin gas impermeable liquid impermeable layer 22 of, for example, polyvinylidene chloride (PVDC) on the innermost surface. The thin layer of PVDC may be bound to the silicone septum by heat fusion, adhesive attachment or other known and acceptable methods. Alternatives to PVCD include any material that is resilient to liquid or gas permeation and may be pierced by a needle. In an alternative embodiment, the liquid impermeable gas impermeable layer 22 is polytetrafluoroethylene (PTFE).

The skirt 12 and top 18 portions of the cap 10 may be entirely made of a resilient relatively hard polymer material such as polypropylene, polystyrene, polyethylene, polycarbonate, or other materials known to those of skill in the art. The container cap may be configured to be threaded for screwing on the container vessel or alternatively may snap fit or press fit with the container top, in either case making a liquid tight seal with the container vessel.

In one embodiment, the septum 18 is secured to the cap top 14 by means of a chemical bond between the silicone of the septum 18 and the polyethylene of the inner surface 24. To facilitate a solid seal, the inner surface 24 of the cap top should be smooth and free of defects so as to provide the maximum surface area interaction between surface 24 and septum 18. In an alternative embodiment, the septum is bonded to the surface with an adhesive. Within the cap top 14 is located a circular access port 26 that will allow access to the container interior through the septum. The access port 26 may be of any size or shape so long as its diameter is less than that of the cap top 14. A gas and liquid impermeable layer comprising a circular disc 28 of peel-able foil is located on the cap top's outer surface 30. The disc may be attached by adhesive. In one embodiment, the disc is made from a foil such as aluminum. In alternative embodiments, the disc is a polymer material known to be impermeable to liquid and gas transfer. In one embodiment, the disc also comprises a pull tab portion that allows a user to peel away the disc when access to the access port is desired. Alternatively, the disc may remain in place and both the septum and disc may be pierced in accessing the contents of the container. The gas and liquid impermeable disc 28 serves at least two functions. It provides a security seal to the sterile contents of the container by ensuring air from the external environment does not enter the container around the septum seal. Further, it provides assurance to the end user that the container and the container contents have not been tampered with. The disc may be any shape or size so long as it fully and effectively covers the access port in an air and fluid secure fashion.

FIG. 3 is a partial section 3 of FIG. 2. It demonstrates the three layer protection against contamination that the cap provides. From the interior of the container outward, a third layer is the gas impermeable liquid impermeable layer bonded to the underside of the 22 septum 18. A first layer is represented by the septum itself. The function of this layer is to provide a re-sealable element such that when access to the interior contents of the container are achieved through a needle, the needle may be removed and the contents re-sealed. In one embodiment, this layer is liquid impermeable. As disclosed previously, septum may be silicone rubber, for example and may be chemically bonded to the inner surface 24 of the cap top 14. A second layer is the outermost disc layer 28 affixed to the upper surface 30 of the cap top 14. In one embodiment, the third or innermost layer 22 as well as second or outermost layer 28 are gas impermeable and liquid impermeable. A single needle can penetrate each of the layers simultaneously in order to access the contents of the container. The first 18 and second 28 layers do not actually contact each other, but are separated by a distance equal to the thickness of the cap top 14.

The cap may be fitted onto a respective neck portion of any of a number of container types including flasks, media bottles, roller bottles, reagent bottles, tubes and vials. Similarly, the container may be any size or volume. In one embodiment, the cap fits onto a disposable Erlenmeyer flask.

In a typical application the container is filled with a predetermined amount of either an aqueous buffered solution or an aqueous microbiological growth medium comprising, for example, a peptone at a certain concentration. The cap is threaded onto the container and container so that the top lip of the container contacts with the top surface of the cap by a compression fit that is fluid-tight. When ready for use in conducting a microbiological assay to assess the degree of sterility in an environment, the peel-away foil may be removed, a sample containing, for example, suspected bacteria is injected into the fluid-containing container to dilute the sample, the mixture is agitated to ensure thorough mixing, and the so-diluted sample is allowed to incubate for an appropriate time period. Following incubation, samples of the contents of the dilution container are deposited on solid growth media in, for example, petri dishes, and colony counts are conducted to identify the nature and degree of bacterial contamination. The remaining contents of the container may be preserved in a sterile condition for possible later assays to specifically identify a possible pathogen by simply screwing the cap back onto the container and storing the vial in an appropriately refrigerated environment.

In another application, media is stored and sent to an end user. In order to test whether the media that has arrived is still of the prescribed pH, one may aseptically access the container contents by needle, removed a sample of media, and test the contents for pH as a quality assurance process.

In still another application, the fluid within the container serves as a diluent to which a concentrated solution is added. So long as the volume remains unchanged and no liquid has escaped the container, accurate concentrations can be obtained. Once the diluent is properly mixed, the septum may be pierced with a spike allowing the user to tip the container and dispense the contents aseptically.

Certain applications may require venting of the contents of the container either at the beginning of an assay, or at some point after addition of biologicals. In an alternative embodiment, instead of a septum having a gas impermeable layer attached thereto, only a liquid impermeable, gas permeable plug exists as the first layer. In this application, the capped container is gas impermeable and liquid impermeable so long as the second gas and liquid impermeable layer engages the cap top. Once the second layer is removed, the contents are vented through the gas permeable first layer.

Although several embodiments of the present invention have been described in the foregoing Detailed Description, it should be understood that the invention is not limited to the embodiments disclosed, but is capable of numerous modifications and substitutions without departing from the sprit of the invention as set forth and defined by the following claims.

What is claimed is:

1. A closure for closing a container with threaded engagement to a neck portion of said container, the closure comprising:
a threaded cap constructed and arranged for threaded engagement to the container, the threaded cap having a circumferential skirt portion and a top, wherein an inner portion of the skirt has a screw thread capable of matingly engaging a screw thread of the neck portion of the container;
a septum connected to an inner surface of the top;
said top having an access port therethrough; and
a gas permeable liquid impermeable layer covering the access port such that no liquid or gas may permeate the access port.

2. The closure of claim 1 wherein said septum is made from silicone rubber and is chemically bonded to an interior surface of the cap top.

3. The closure of claim 1 further comprising an innermost layer of gas impermeable liquid impermeable material bonded to a bottom surface of said septum.

4. The closure of claim 1 wherein said septum is a gas permeable liquid impermeable material.

5. The closure of claim 1 wherein said septum is made from a gas impermeable, liquid impermeable material.

6. A cap for liquid and air tight attachment to a container comprising:
a circumferential skirt attached to a circular top, the top having an outer surface and an inner surface;
an access port through said top extending from said outer surface to said inner surface;
a first layer of liquid impermeable material bonded to said inner surface of said top at an interface and covering said access port;
a second layer of gas impermeable, liquid impermeable material bonded to said outer surface of said top thereby covering said access port; and
wherein a single needle can permeate both layers simultaneously.

7. The cap of claim 6, further comprising a third layer of gas impermeable liquid impermeable material bonded to said first layer on a side opposing the interface.

8. The cap of claim 6 wherein the material of said first layer is a silicone rubber.

9. The cap of claim 6 wherein the material of the second layer is foil.

10. The cap of claim 7 wherein the material of the third layer is polyvinylidene chloride.

11. A container for holding liquid having a threaded neck and engaged with the closure of claim 1.

12. The container of claim 11 wherein the container is a media bottle.
